(19) United States
(12) Patent Application Publication
(10) Pub. No.: US 2024/0429388 A1
(43) Pub. Date: Dec. 26, 2024

(54) CARBON- OR GRAPHITE-BASED ANODE ACTIVE MATERIALS FROM BIOMASS-DERIVED ACTIVATED CARBON

(71) Applicant: Honeycomb Battery Company, Dayton, OH (US)

(72) Inventors: Song-Hai Chai, Dayton, OH (US); Bor Z. Jang, Centerville, OH (US)

(73) Assignee: Honeycomb Battery Company, Dayton, OH (US)

(21) Appl. No.: 18/333,876

(22) Filed: Jun. 13, 2023

(51) Int. Cl. H01M 4/587; C01B 32/205; C01B 32/318; C01B 32/342; C01B 32/354

(52) U.S. Cl. CPC H01M 4/587; C01B 32/205; C01B 32/318; C01B 32/342; C01B 32/354; C01P 2004/03; C01P 2004/61; C01P 2004/62; C01P 2004/64; C01P 2006/16; C01P 2006/40

(57) ABSTRACT

A method of producing graphitic or carbonaceous particles from activated carbon, the method comprising (a) providing particles of activated carbon having pores, wherein the pores have a volume fraction from 20% to 99.9% (preferably from 50% to 95%); (b) impregnating or infiltrating the pores with a carbon precursor to form composite particles comprising activated carbon particles having pores partially or fully filled with the carbon precursor; and (c) heat-treating the composite particles to convert the carbon precursor to a carbonaceous material or a graphitic material that reside in the pores or merged with a structure (e.g., pore walls) of the activated carbon. The activated carbon particles are preferably obtained by heat-treating a biomass feedstock and activating the heat treated biomass (e.g., biochar). The biomass heat-treating and the activation procedures can be conducted sequentially or concurrently.

### FIELD

The present invention relates to the art of anode active materials for lithium-ion or sodium-ion batteries and, in particular, to a method of producing graphite or hard carbon-based anode active materials from renewable sources.

### BACKGROUND

Concerns over the safety of earlier lithium secondary batteries led to the development of lithium-ion secondary batteries, in which a carbonaceous material is used as an anode active material. The carbonaceous material may comprise primarily graphite that can be intercalated with lithium and the resulting graphite intercalation compound may be expressed as LiₓC₆, where x is typically less than 1. In order to minimize the loss in energy density, x in LiₓC₆ must be maximized and the irreversible capacity loss Qᵢᵣ in the first charge of the battery must be minimized. Carbon anodes can have a long cycle life due to the presence of a protective solid-electrolyte interface layer (SEI), which results from the reaction between lithium and the electrolyte during the first several cycles of charge-discharge. The lithium in this reaction comes from some of the lithium ions originally released from the cathode and intended for the charge transfer purpose. As the SEI is formed, the lithium ions become part of the inert SEI layer and become irreversible, i.e., these lithium atoms can no longer be shuttled back and forth between the anode and the cathode. Therefore, it is desirable to use a minimum amount of lithium for the formation of an effective SEI layer. In addition to SEI formation, Qᵢᵣ has been attributed to graphite exfoliation caused by electrolyte solvent co-intercalation and other side reactions.

The maximum amount of lithium that can be reversibly intercalated into the interstices between graphene planes of a theoretically perfect graphite crystal is generally believed to occur in a graphite intercalation compound represented by LiₓC₆ (x=1), corresponding to a theoretical specific capacity of 372 mAh/g. In other “graphitized carbon materials” than pure graphite crystals, there exists a certain amount of amorphous or disordered carbon phase and a significant amount of graphite crystallites dispersed in the disordered phase. Each crystallite is typically composed of a number of graphene sheets (basal planes) that are stacked and bonded together by weak van der Waals forces along the crystallographic c-axis direction. The number of graphene sheets varies between just a few and several hundreds, giving rise to a c-directional dimension (thickness Lc) of typically a few nanometers to several hundreds of nanometers (nm). The length or width (La) of these crystallites is typically between tens of nanometers to microns.

The amorphous or disordered phase is a source of irreversible capacity loss since lithium stored in this phase tends to stay therein and does not come out during the subsequent discharge cycle, resulting in a significant drop of reversible capacity. Furthermore, an amorphous carbon phase tends to exhibit a low electrical conductivity (high charge transfer resistance) and, hence, a high polarization or internal power loss. Generally speaking, the amount of amorphous phase should be as small as possible in order to minimize the degree of irreversibility. The amorphous carbon phase is extensively present in carbon-based materials such as hard carbon (non-graphitizable carbon even when heat-treated at a temperature higher than 2,500° C.), soft carbon (graphitizable carbon), and meso-phase micro beads (MCMBs).

The graphitic or carbonaceous materials that can be converted into an anode material for a lithium-ion cell or sodium-ion cell include natural flake graphite, synthetic graphite, hard carbon, soft carbon, MCMBs, micron-scaled carbon or graphite fibers (typically having a diameter in the range of 6-12 μm), and vapor-grown carbon nano-fibers (VG-CNFs) having a diameter typically lower than 100 nm. Both natural and synthetic graphite materials typically have a wide variety of functional groups (e.g., carbonate, hydrogen, carboxyl, lactone, phenol, carbonyl, ether, pyrone, and chromene) at the edges of crystallites defined by La and Lc. These groups can react with lithium and/or electrolyte species to form a so-called in situ CB-SEI (chemically bonded solid-electrolyte interface) on which, for example, carboxylic acid surface films are converted into Li-carboxylic salts. In other words, this SEI layer consumes a certain amount of lithium during the first few charge/discharge cycles and, hence, is a source of irreversibility as well. On a more positive note, this SEI layer can protect natural graphite by preventing solvent-induced exfoliation of natural flake graphite.

Mining of natural graphite is generally considered as a highly polluting process due to the use of undesirable chemicals. Particles of synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon-based anode materials with scalable synthesis/fabrication processes from sustainable sources.

In this context, carbon anode materials from biomass resources are potential candidate anode active materials due to their ease in processing and handling, non-toxicity, and worldwide availability and abundance. However, biomass-derived carbon materials tend to contain highly porous internal structures after an initial heat treatment. Although a porous anode structure can be a desirable feature for use in a supercapacitor which demands a high specific surface area (m²/g), such a feature is typically viewed as undesirable when a porous carbon is used as a lithium-ion cell anode material. A high specific surface area, if not properly controlled, can lead to a high amount of SEI by consuming a large amount of lithium ions and liquid electrolytes during the first few charge-discharge cycles, resulting in a low first-cycle efficiency and short cycle life.

It is desired to have biomass-derived graphite or carbon materials that, when used as an anode active material of a lithium-ion battery or sodium-ion battery, exhibit excellent charge-discharge characteristics at both low and high charge/discharge rates.

It is further desired to have a method or process that is capable of cost-effectively producing such a carbon or graphite material at scale.

### SUMMARY

The present disclosure provides a simple, fast, scalable, environmentally benign, and cost-effective process or method of producing carbon- or graphite-based anode active materials that meets the afore-mentioned needs.

In certain embodiments, the present disclosure provides a method of producing graphitic or carbonaceous particles from activated carbon, the method comprising (a) providing particles of activated carbon having pores, wherein the pores have a volume fraction from 20% to 99.9% (preferably >40% and more preferably >60%); (b) impregnating or infiltrating the pores with a carbon precursor to form composite particles comprising activated carbon particles having pores partially or fully filled with the carbon precursor; and (c) heat-treating the composite particles to convert the carbon precursor to a carbonaceous material or a graphitic material that resides in the pores or merged with a structure (e.g., the pore walls) of the activated carbon. These pores are preferably interconnected to allow for infiltration of pores by the carbon precursor (e.g., petroleum pitch, bio-pitch, polymer, polyaromatic molecules, etc.).

The pores of activated carbon particles preferably have a pore size greater than 50 nm, a porosity greater than 50% by volume, or comprise interconnected pores or through pores.

Preferably, step (a) of providing particles of activated carbon comprises heat-treating a biomass feedstock at a first heat treatment temperature for a first period of time to obtain biochar particles having a size from 10 nm to 10 mm and, concurrently or subsequently, activating the biochar particles to obtain particles of activated carbon and wherein step (c) comprises heat-treating the composite particles at a second temperature for a second period of time wherein the second temperature is higher than the first heat treatment temperature and comprises a temperature selected from 900° C. to 3,500° C. (typically from 1,000° C. to 3,200° C. and more typically from 1,500° C. to 3,000° C.).

In certain embodiments, the biochar particles are produced by heat treating the biomass feedstock at a first temperature selected from a range of 100° C. to 1,500° C. for a first period of time to produce partially or fully carbonized biochar particles (herein referred to as the first heating step). Optionally (if the biochar particles are substantially larger than 1 mm, for instance), this procedure is followed by mechanically reducing the size of the biochar particles (e.g., crushing, grinding, granulating, milling, etc.) to an average size range approximately from 10 nm to 10 mm (preferably no greater than 1 mm, more preferably less than 100 μm, and further preferably less than 20 μm, and most preferably less than 10 μm).

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The biomass feedstock can be a mixture of a biomass with particles (chips, granules, flakes, etc.) of a recycled plastic.

In some embodiments, the carbon precursor is selected from petroleum heavy oil or pitch, coal tar pitch, a polynuclear hydrocarbon, a polymer, or a combination thereof. The polynuclear hydrocarbon may be selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

There is no theoretical restriction on the type of polymer that can be used as a carbon precursor, but preferably the polymer, when carbonized, has a carbon yield of greater than 10%, more preferably greater than 20%, further preferably greater than 30%, and most preferably greater than 50%. The polymer as a carbon precursor may be selected from polyacrylonitrile (PAN), polyvinyl chloride (PVC), polyether ether ketone (PEEK), polysulfone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof. The carbon precursor can be selected from a recycled plastic.

In certain embodiments, the biomass feedstock prior to the first heat-treating step or the biochar prior to the second heat-treating step comprises particles of a recycled plastic.

In some embodiments, the biomass comprises an activation agent, which may be selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

In some embodiments, the biomass comprises an additive dispersed in the biomass during the first heat treating step or the biochar comprises an additive dispersed therein, wherein the additive is selected from a catalyst, a template, an activator or activation agent, a chemical functionalization agent, or a combination thereof, wherein the additive regulates a thermal transformation process of the biomass during the heat-treating step.

In some preferred embodiments, the catalyst comprises a transition metal selected from Ti, V, Cr, Mn, Fe, Co, Ni, Cu, Zn, Zr, Nb, Mo, Ru, Pd, Ag, Cd, Pt, Au, a combination thereof, or the catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.

The template may be selected from graphene oxide (GO), NaCl, and Ca-based salts. Catalysts, such as Fe-based (e.g., Fe(NO₃)₃, FeCl₃), Ni-based (e.g., NiCl₂, nickel nitrate), and Co-based (e.g., CoCl₂), may be added with a biomass to promote or facilitate organization or ordering of the aromatic domains.

The activation agent, as examples, may be selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

Preferably, the biochar particles have a density from 0.01 to 0.5 g/cm³, after the first heat-treating step, and the final graphitic or carbonaceous particles have a density from 1.4 to 2.26 g/cm³. With the presence of an activation agent mixed in the biomass feedstock during the first heat-treating step, the procedure involves concurrent carbonization and chemical activation, resulting in a biochar that is highly porous (density of 0.01 to 0.5 g/cm³), which is essentially an activated carbon (AC). The carbon precursor can partially or fully fill the pores of the AC particles and the final products (graphitic or carbonaceous particles) can be highly dense.

In some embodiments, the first heat treating step comprises a hydrothermal carbonization (HTC) at an HTC temperature selected from 100° C. to 600° C. for a first duration of time, and the second heat treating step comprises a pyrolysis procedure at a pyrolysis temperature higher than the selected HTC temperature for a second length of time. In some embodiments, a catalyst, a template, an activator, a chemical functionalization agent, or a combination thereof is present during the HTC and/or pyrolysis procedure.

The hydrothermal carbonization may comprise heat treating the biomass feedstock to induce decomposition of biomass molecules, polymerization, and/or aromatization at a desired first temperature and under a desired pressure for a first length of time for forming a mixture of graphene domains dispersed in a disordered matrix of carbon or hydrocarbon molecules, wherein the graphene domains are each composed of one or a plurality of planes of hexagonal carbon atoms or fused aromatic rings having a length or width from 5 nm to 10 μm. These graphene domains lead to a graphite structure during the second heat-treating step.

The biomass can contain lignocellulosic and/or non-lignocellulosic biomass. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc.

The nonlignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

In some preferred embodiments, the heat-treating procedure comprises (i) a hydrothermal carbonization (HTC) at an HTC temperature selected from 100° C. to 600° C. and (ii) a pyrolysis procedure at a pyrolysis temperature higher than the selected HTC temperature. The additive (a catalyst, a template, an activation agent, and/or a chemical functionalization agent) may be present during the HTC and/or the pyrolysis procedures.

The heat treatments serve to chemically transform the aromatic molecules (derived from biomass molecules) into “graphene domains” dispersed in or connected to a disordered matrix of carbon or hydrocarbon molecules. The matrix is characterized by having amorphous and defected areas of carbon or hydrocarbon molecules. These graphene domains can include individual single planes of hexagonally arranged carbon atoms (“graphene planes”) or multiple graphene planes (2-20 hexagonal carbon planes stacked together) that are embedded in or connected to disordered or defected areas of carbon or hydrocarbon molecules, which can contain other atoms (such as N, S, etc.) than C, O, and H.

In some embodiments, functionalizing agents contain a chemical functional group selected from alkyl or aryl silane, alkyl or aralkyl group, hydroxyl group, carboxyl group, amine group, sulfonate group (—SO₃H), aldehydic group, quinoidal, fluorocarbon, or a combination thereof.

In certain embodiments, the functionalizing agent contains an azide compound selected from the group consisting of 2-Azidoethanol, 3-Azidopropan-1-amine, 4-(2-Azidoethoxy)-4-oxobutanoic acid, 2-Azidoethyl-2-bromo-2-methylpropanoate, chlorocarbonate, azidocarbonate, dichlorocarbene, carbene, aryne, nitrene, (R-)-oxycarbonyl nitrenes, where R=any one of the following groups,

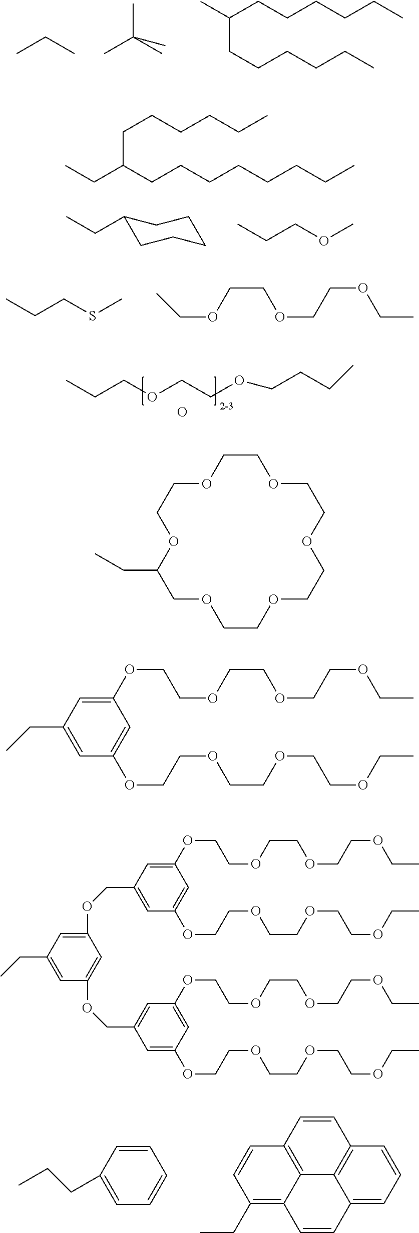

and combinations thereof.

In certain embodiments, the functionalizing agent contains an oxygenated group selected from the group consisting of hydroxyl, peroxide, ether, keto, and aldehyde. In certain embodiments, the functionalizing agent contains a functional group selected from the group consisting of SO₃H, COOH, NH₂, OH, R′CHOH, CHO, CN, COCl, halide, COSH, SH, COOR′, SR′, SiR′₃, Si(—OR′—)_{y}R′_{3-y}, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

The functionalizing agent may contain a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof. The functionalizing agent may contain an acrylonitrile chain, polyfurfuryl alcohol, phenolic resin, or a combination thereof.

In some embodiments, the functionalizing agent contains a functional group selected from OY, NHY, O═C—OY, P=C—NR′Y, O═C—SY, O═C—Y, —CR′1—OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)W—R′, (C₃H₆O)_{w}—R′, R′, and w is an integer greater than one and less than 200.

### BRIEF DESCRIPTION OF THE DRAWINGS

FIG. 1(A) A flow chart showing the most commonly used prior art process of producing powder of hard carbon or graphite from a biomass feedstock.

FIG. 1(B) A flow chart showing the most commonly used prior art process of producing highly porous carbon or graphite from a biomass feedstock.

FIG. 2 A flow chart showing the presently invented process for producing graphite or carbon-based anode active materials from activated carbon for lithium-ion or sodium-ion cells from a biomass according to some embodiments of the present invention.

FIG. 3 A SEM image of biomass-derived activated carbon.

FIG. 4 A SEM image of biomass-derived, high temperature treated graphite powder containing irregular-shape particles.

FIG. 5 A SEM image of biomass-derived, high temperature treated graphite-based anode active material according to an embodiment of the present disclosure.

### DETAILED DESCRIPTION

Carbon materials can assume an essentially amorphous structure (glassy carbon), a highly organized crystal (graphite), or a wide range of intermediate structures that are characterized in that various proportions and sizes of graphite crystallites and defects are dispersed in an amorphous carbon matrix. Typically, a graphite crystallite is composed of multiple graphene planes (planes of hexagonal structured carbon atoms or basal planes) that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a natural graphite flake, artificial graphite bead, carbon/graphite fiber segment, carbon/graphite whisker, or carbon/graphite nano-fiber.

Mining and purification of natural graphite is generally considered as a highly polluting process due to the use of undesirable chemicals. Alternatively, synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon-based anode materials with scalable synthesis or fabrication processes primarily from sustainable sources with a minimal use of petroleum or coal source.

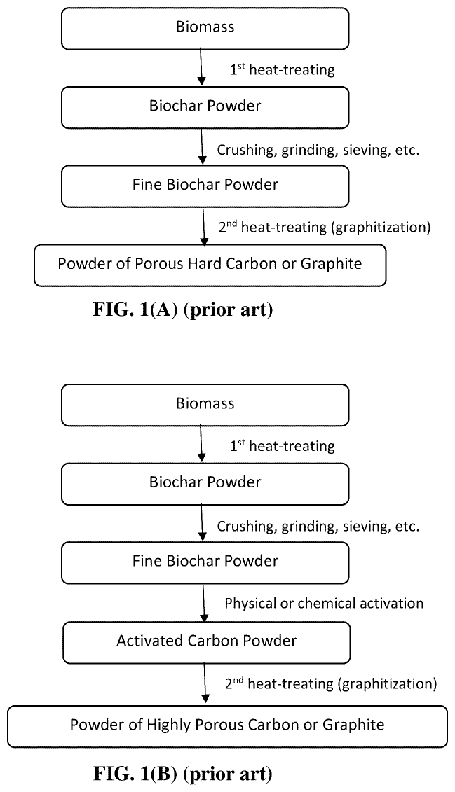

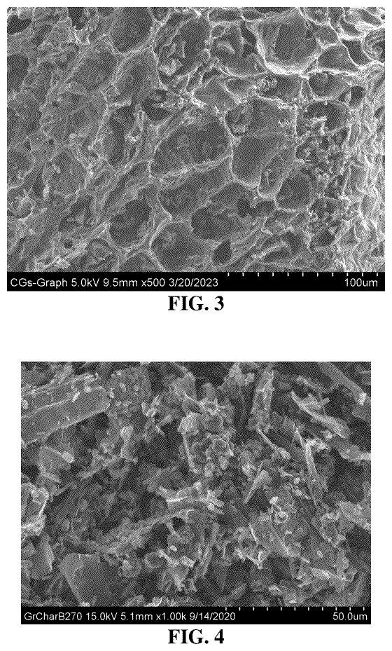

FIG. 1(A) and FIG. 1(B) illustrate the processes for producing biochar products, with or without a physical or chemical activation treatment. Biomass-derived carbon materials tend to contain highly porous internal structures after an initial heat treatment (e.g., FIG. 3), with or without an activation procedure. Although a porous anode structure can be a desirable feature for use in a supercapacitor which requires a high specific surface area (m²/g), such a feature is typically viewed as undesirable when a porous carbon is used as a lithium-ion cell anode material. A high specific surface area, if not properly controlled, can lead to a high amount of solid-electrolyte interphase (SEI) that consumes a large amount of lithium ions and liquid electrolytes during the first few charge-discharge cycles, resulting in a low first-cycle efficiency and short cycle life.

The present disclosure provides a simple, fast, scalable, environmentally benign, and cost-effective process or method of producing carbon or graphite-based anode active materials that meets the afore-mentioned needs.

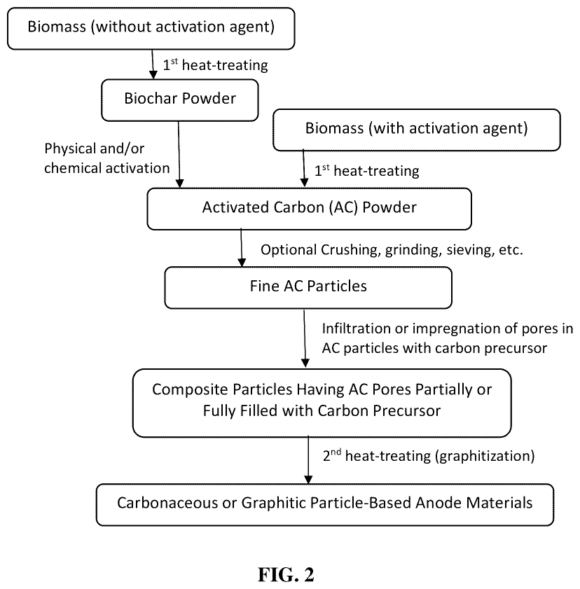

In some embodiments of instant disclosure, as schematically illustrated in FIG. 2, the method of producing graphitic or carbonaceous particles comprises: (a) providing particles of activated carbon having pores, wherein the pores have a volume fraction from 20% to 99.9% (preferably >40% and more preferably >60%); (b) impregnating or infiltrating the pores with a carbon precursor to form composite particles comprising activated carbon particles having pores partially or fully filled with the carbon precursor; and (c) heat-treating the composite particles to convert the carbon precursor to a carbonaceous material or a graphitic material that resides in the pores or merged with a structure (e.g., the pore walls) of the activated carbon. These pores are preferably interconnected to allow for infiltration of pores by the carbon precursor (e.g., petroleum pitch, bio-pitch, polymer, polyaromatic molecules, etc.).

Preferably, step (a) of providing particles of activated carbon comprises heat-treating a biomass feedstock at a first heat treatment temperature for a first period of time to obtain biochar particles having a size from 10 nm to 10 mm and, concurrently or subsequently, activating the biochar particles to obtain particles of activated carbon and wherein step (c) comprises heat-treating the composite particles at a second temperature for a second period of time wherein the second temperature is higher than the first heat treatment temperature and comprises a temperature selected from 900° C. to 3,500° C. (typically from 1,000° C. to 3,200° C. and more typically from 1,500° C. to 3,000° C.).

The pores of activated carbon particles preferably have a pore size greater than 50 nm, a porosity greater than 50% by volume, or comprise interconnected pores or through pores. These are more conducive to filling of pores with liquid precursor to carbon. Certain chemical functional groups on the pore walls of AC particles can improve the wettability of the carbon precursor liquid, facilitating the entry of the liquid.

In certain embodiments, the biochar particles are produced by heat treating the biomass feedstock at a first temperature selected from a range of 100° C. to 1,500° C. for a first period of time to produce partially or fully carbonized biochar particles; this step is herein referred to as the first heating step. This step may be followed with physical or chemical activation of the biochar particles to form activated carbon (AC) particles. Preferably, this first heating step is conducted concurrently with the chemical activation step by adding an activating agent into the biomass feedstock prior to heat treating. The activated carbon particles preferably have a porosity level of greater than 50% by volume and/or a network of interconnected pores to enable easy entry of carbon precursor liquid into the pores and transport of carbon precursor liquid between pores inside an AC particle.

Optionally (if the biochar particles or AC particles are substantially larger than 1 mm, for instance), this procedure is followed by mechanically reducing the size of the biochar particles (e.g., crushing, grinding, granulating, milling, etc.) to an average size range from approximately 10 nm to 10 mm (preferably no greater than 1 mm, more preferably less than 100 μm, and further preferably less than 20 μm, and most preferably less than 10 μm).

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc. The non-lignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

As non-limiting examples, some of the biomass species that can be processed using the presently disclosed method are rice husk, recycled paper cup, hemp, shrimp or other types of soft shells, willow catkins, corn stalk, corn powder, corn cob, coconut shell, wheat straw, spruce bark, camphor leaves, banana peel, Coprinus comatus, nori, honey suckles, waste peanut shell, eggplant, wood chips, seaweed, soya bean, glucose, etc. This list is meant to illustrate the fact that a wide variety of sustainable products can be used and processed into graphene sheets. One can even convert agricultural and wood waste into highly valuable products.

In some embodiments, the carbon precursor is selected from petroleum heavy oil or pitch, coal tar pitch, a polynuclear hydrocarbon, a polymer, or a combination thereof. The carbon precursor is preferably in a liquid or liquid solution state to enable flowing into pores of the AC particles. The polynuclear hydrocarbon may be selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

There is no theoretical restriction on the type of polymer that can be used as a carbon precursor, but preferably the polymer, when carbonized, has a carbon yield of greater than 10%, more preferably greater than 20%, further preferably greater than 30%, and most preferably greater than 50%. The polymer as a carbon precursor may be selected from polyacrylonitrile (PAN), polyvinyl chloride (PVC), polyether ether ketone (PEEK), polysulfone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof.

In some embodiments, the biomass comprises an additive dispersed in the biomass for the first heat treating step or the carbon precursor comprises an additive dispersed therein for the second heat treating step. The additive is selected from a catalyst, a template, an activator or activation agent, a chemical functionalization agent, or a combination thereof, wherein the additive regulates a thermal transformation process of the biomass during the heat-treating step or promotes graphitization of the biochar during the second heat treating step.

The template may be selected from graphene oxide (GO), NaCl, and Ca-based salts. Examples of activators are KOH and NH₄Cl. Examples of catalysts are Fe-based (e.g., Fe(NO₃)₃, FeCl₃), Ni-based (e.g., NiCl₂, nickel nitrate), and Co-based (e.g., CoCl₂), B, P, and various transition metals. The activation agent may be selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

Thus, in certain embodiments of the present disclosure, the catalyst comprises a transition metal selected from B, P, Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.

Typically, the AC particles have a density from 0.01 to 0.5 g/cm³, after the first heat-treating step and activation, and the graphitic or carbonaceous particles have a density from 1.4 to 2.26 g/cm³ after the second heat treatment. In some cases, with the presence of an activation agent mixed in the biomass feedstock during the first heat-treating step, the procedure involves concurrent carbonization and chemical activation, resulting in AC particles that are highly porous (density of 0.01 to 0.5 g/cm³). Alternatively, AC can be produced by physical or chemical activation of biochar after the first heat treatment. Preferably, the pores have a size greater than 50 nm, more preferably greater than 500 nm, and most preferably greater than 5 μm. Further preferably, the pores are interconnected or contain through holes.

The carbon precursor can partially or fully fill the pores of the AC particles and the final products (graphitic or carbonaceous particles) can be highly dense. This can significantly reduce the amount of solid-electrolyte interface (SEI) and thereby improving the first cycle efficiency and cycle life of a lithium-ion cell or sodium-ion cell.

We have surprisingly observed that, given the same original biomass, the graphitic particles that went through carbonization, activation (to produce larger pores by removing certain weaker or less ordered portion of biochar), carbon precursor infiltration, and graphitization procedures typically have the following characteristics: (a) higher degree of graphitization; (b) higher physical density; (c) higher specific capacity (when used as an anode active material in a lithium-ion cell); and (d) higher first-cycle efficiency. These characteristics are in comparison with the graphitic particles from the same biomass, but did not go through the activation and carbon precursor infiltration procedures.

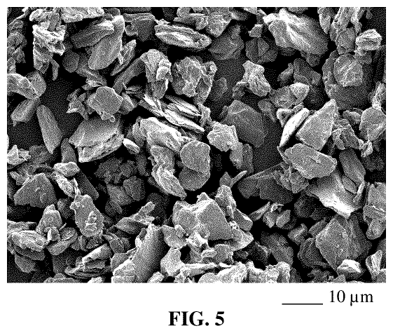

It is of interest to note that the biochar-derived graphitic or carbon powder using the prior art process (FIG. 1) tends to contain particles that are highly irregular in shape (e.g., FIG. 4) and particle sizes have a broad distribution, from very small particles to very large particles. These features make it difficult to produce anode electrodes in a consistent manner. The resulting electrodes also tend to have a relatively low packing density, leading to a lower energy density per unit volume of a battery cell. These issues are well addressed by the presently disclosed method of producing graphite from composite particles that contain AC particles having pores filled with carbon precursor. The biochar particles are preferably reduced in size to make the pores of AC particles more readily accessible to liquid carbon precursor. The resulting particulates are relatively uniform in size and regular in shape (e.g., FIG. 5).

In some preferred embodiments, the heat-treating procedure comprises (i) a hydrothermal carbonization (HTC) at a HTC temperature selected from 100° C. to 500° C. (at a pressure of typically from 1.1-10 atm) for a first length of time, and (ii) a pyrolysis procedure at a pyrolysis temperature, higher than the selected HTC temperature, for a second length of time. The additive (a catalyst, a template, an activation agent, and/or a chemical functionalization agent) may be present during the HTC and/or the pyrolysis procedures. The chemical or mechanical means is operated during the HTC and/or pyrolysis.

In some embodiments, the invented method begins with heat-treating a biomass at a temperature selected from the range of 100° C. to 1,200° C., more preferably from 120° C. to 1,000° C., and further preferably from 150° C. to 1,000° C. In some preferred embodiments, the heat treatments include a first heat treatment temperature preferably in the range of 100° C. to 600° C. for a heat treatment time of preferably 0.2 to 24 hours (typically under a pressure of 1.1-10 atm). This is followed by a second heat treatment at a second temperature from 300° C. to 1,500° C. (more typically 600° C. to 1,000° C.) for preferably 0.2 to 24 hours.

At the first heat treatment temperature of 100° C. to 300° C., the biomass can get decomposed and undergo dehydrogenation polymerization that entails removal of non-carbon atoms, such as H and N, and lateral merging of fused aromatic rings to form longer and wider aromatic molecules (polyaromatic molecules) or more aromatic rings fused together in the length and width directions, much like growing polymer chains. The carbon precursor, typically being already highly aromatic or capable of forming fused ring structure, serves as a seed for promoting the formation and growth of more and larger graphene planes. Such a structure of fused aromatic rings can grow to contain up to 300 carbon atoms or approximately 100 rings fused together. Such a structure is an incipient graphene sheet.

At a second heat treatment temperature selected from 600° C. to 3,000° C., these incipient graphene sheets continue to grow in lateral dimensions (length and width) which can reach several micrometers and the resulting graphene sheets can each contain may thousands of fused rings. These dimensions and number of fused rings can be determined by using transmission electron microscopy (TEM) and atomic force microscopy (AFM).

By including a catalyst in the biomass feedstock (prior to the first heat-treating step) or in the biochar (prior to the second heat-treating), one can significantly accelerate the graphite formation process and reduce the required graphitization temperature.

The following examples serve to provide the best modes of practice for the present invention and should not be construed as limiting the scope of the invention:

### Example 1: Production of Carbon/Graphite from Non-Lignocellulosic Biomass-Derived Activated Carbon (AC) Particles

Powder of graphitic materials was produced from activated carbon (AC) heat treated fruit-based non-lignocellulosic biomass. The fruits of glossy privet were washed and dried at 80° C. for 6 h. Then, the fruits (22.328 g) were put into an autoclave (0.5 L) containing deionized water (200 mL) and H₃PO₄ (40 mL, as a chemical activation agent). The autoclave was subjected to a hydrothermal reaction at 195° C. for 36 h. A dark-brown solid was obtained by filtrating, washing with deionized water until reaching a neutral state, followed by drying at 70° C. for 3 h. This biochar was an activated carbon.

In this study, phenolic resin was used as the carbon precursor. A mixture of 54 grams (g) of phenol, 25 g orthocresol, 32.1 g of 37% formaldehyde in water solution, and 1 g of zinc acetate dehydrate was heated to 90° C. with stirring for 2 hours to form a novalac liquid. A liquid solution containing 75% of the novalac liquid mixed with 25% of divinylbenzene was prepared. Particles of activated carbon were then immersed in the liquid solution for 10 minutes, forming a slurry. Subsequently, methane sulfonic acid (0.5 weight percent, based on the weigh of the novalac) was added to this slurry, allowing the reacting mass a sufficient period of time (typically 20-6 minutes) to permeate into pores of the AC particles. The mixture was cured at 45° C. for 1 hour to form a highly cross-linked resin inside pores of the AC particles.

The resin-filled AC particles were calcinated at 1,450° C. for 2 h in N₂ at a heating rate of 5° C./min to obtain graphitized particles. A sample of these graphite particles was mixed with SBR binder and water to form a slurry, which was coated onto a surface of a Cu foil to form an anode (negative electrode). This anode was tested in a half-cell configuration with a lithium metal foil as a counter electrode. The first cycle efficiency was found to be 92.3% and first cycle delithiation capacity was 335 mAh/g.

### Comparative Example 1: Without Activation and Phenolic Resin Impregnation

For comparison, a sample was obtained under similar processing conditions, but without the use of a chemical activation agent and without carbon precursor coating procedure. The first cycle efficiency was found to be 88.6% and first cycle delithiation capacity was 281 mAh/g.

### Example 2: Graphite from Non-Lignocellulosic Biomass-Based AC

Chitosan is an abundant type of biomass (e.g., from shrimp shell). Chitosan may be converted into graphite with or without using a catalyst. In the present study, a two-step procedure was conducted, which included using FeCl₃ as a catalyst in a chitosan/FeCl₃ mixture and heat-treating the mixture. The residual Fe could be removed and recovered by acid washing.

In a typical process, chitosan and FeCl₃ were mixed in de-ionized (DI) water and dried at 80° C. to obtain a brown chitosan/FeCl₃ mixture. Then, the mixture was heated in a sealed furnace under Ar atmosphere at 400° C. for 2 hours to generate a biochar powder. The biochar powder was divided into two samples. The first sample was mixed with KOH and heated at 850° C. for 2 hours to produce particles of activated carbon. The AC particles were then immersed in a petroleum pitch solution, which was slightly heated to allow the pitch solution to permeate into pores of AC. The second sample did not go through the chemical activation and pitch permeation procedures, but was mixed with the pitch to form secondary particles. Both samples were then subjected to graphitization at 2,400° C. for 4 hours (the second heat treatment) to form anode active materials.

Each of the two anode material samples was separately mixed with SBR binder (6% by weight) and water to form a slurry, which was coated onto a surface of a Cu foil to form an anode (negative electrode). For both types of anode electrodes, electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The first cycle efficiency of the secondary particle-based graphite anode was found to be 94.6% and first cycle delithiation capacity was 341 mAh/g. In contrast, with activation and carbon precursor infiltration, the resulting graphite-based anode material exhibits a first cycle efficiency was 95.7 and first cycle delithiation capacity was 353 mAh/g. The physical density of the carbon precursor filled AC-derived graphite is approximately 1.95 g/cm³, but that of the secondary particles-derived graphite is 1.62 g/cm³; the former delivers a much higher capacity per unit volume, leading to a higher volumetric energy density. The differences are quite significant.

### Example 3: Graphite Anode Materials from Lignocellulosic Biomass-Derived Activated Carbon

The Kraft lignin with iron ions was prepared by the co-precipitation method. In a representative procedure, thirty (30) grams of Kraft lignin was first added to 30 mL tetrahydrofuran in a glass beaker and stirred for 2 h. Separately, 25 grams of iron(III) nitrate was added to 20 mL DI water in a smaller glass beaker and the mixture was stirred until dissolved completely. Subsequently, the iron nitrate solution was added drop-wise to the Kraft lignin solution and stirred for 2 h. The mixture was sealed in an autoclave and heated at 180° C. for 4 hours. The resulting partially reacted mixture was then mixed with ZnCl₂, as a chemical activation agent, and treated at 600° C. for 2 h to produce activated carbon particles.

A sample of activated carbon particles was dispersed in naphthalene liquid at 90° C. for 1 hour. These naphthalene-filled AC particles were packed in the middle of a 1-inch OD, stainless steel tubular reactor. The reactor was heated at a rate of 10° C./min to 1,500° C. and maintained at 1,500° C. for 1 h. Then, the furnace was cooled down at a rate of 10° C./min to room temperature. Another batch of sample was prepared in a similar manner using a zirconia furnace, but the temperature was raised to 2,400° C. and maintained at this temperature for 2 hours.

### Example 4: Graphite Anode Materials from Lignocellulosic Biomass-Derived Activated Carbon

The precursor cellulose was prepared by mechanical milling. In a representative process, 50 g of bleached kraft pulp was loaded to a 500 ml PTFE pot containing zirconia balls of three size and numbers: 2 of 20 mm diameter, 100 of 10 mm diameter, and 300 of 6 mm diameter (631 g in total). Milling was conducted by a planetary ball mill at 300 rpm for 24 h. The obtained milled sample was used to prepare activated carbon with KOH swelling and intercalation, followed by high temperature activation. In an example, 2 g of milled cellulose was immersed in 100 ml of 10 wt % KOH and the resulting suspension was stirred at 5° C. for 2 h. Subsequently, the cellulose was filtrated and dried in an oven. The dried powder-like sample was calcined in a furnace at a temperature (600 and 700° C., respectively) for 1 h with a heating rate of 10° C./min under a nitrogen atmosphere. Upon cooling back to room temperature, the sample was immersed in a solution of 1 M HCl in deionized water, repeatedly rinsed with water, and then dried at 100° C. in an oven overnight. The product was activated carbon.

The activated carbon (AC) was immersed in a liquid solution that contained poly (furfuryl alcohol), PFA, dissolved in acetone. The PFA-filled AC particles were treated at 400° C. for 2 hours. This procedure of PFA filling and carbonization was repeated for another run. The particles were subjected to graphitization at 2,400° C. for 2 hours to produce the desired graphitic particles.

### Example 5: Graphite Anode Materials from Mixed Lignocellulosic/Non-Lignocellulosic Biomass

Sugarcane bagasse pith was obtained by squeezing and extracting sugarcane juice from the sugarcane purchased from a supermarket. Then, the sugarcane bagasse pith (5 g) was suspended in 500 ml of distilled water containing 1 wt % glacial acetic acid dissolved therein. Chitosan (2.14 g) was then added into the acetic solution with continuous stirring until chitosan was completely dissolved. The resulting suspension was stirred for about 5 h at room temperature, and dried at 80° C. in an oven. The sugarcane bagasse pith/chitosan mixture was first heat-treated in an autoclave (180° C. at 2 atm pressure) for 1 hr. The resulting partially carbonized mass was then mixed with KOH and heated in a tube furnace for 1 h at 850° C. in Ar atmosphere with a ramp rate of 3° C./min to obtain a sample of AC particles.

A desired amount of recycled PAN fibers was dissolved in dimethylformamide (DMF) to form a solution. The highly porous AC particles were then immersed in this solution, allowing the PAN solution to permeate into the pores of AC particles. The slurry was spray-dried to form PAN-filled AC particles, which were heat treated initially to 300° C., then 1,200° C., and then finally 2,550° C. for 2 hours to obtain graphite particles.

The presently disclosed method is simple, fast, cost-effective, and generally does not make use of undesirable chemicals. The starting materials are primarily biomass, which is considered a sustainable source.

1. A method of producing graphitic or carbonaceous particles from activated carbon, said method comprising (a) providing particles of activated carbon having pores, wherein the pores have a volume fraction from 20% to 99.9%; (b) impregnating or infiltrating the pores with a carbon precursor to form composite particles comprising activated carbon particles having pores partially or fully filled with said carbon precursor; and (c) heat-treating said composite particles to convert said carbon precursor to a carbonaceous material or a graphitic material that reside in the pores or merged with a structure of the activated carbon.

2. The method of claim 1, wherein said step (a) of providing particles of activated carbon comprises heat-treating a biomass feedstock at a first heat treatment temperature for a first period of time to obtain biochar particles having a size from 10 nm to 10 mm and, concurrently or subsequently, activating the biochar particles to obtain particles of activated carbon and wherein said step (c) comprises heat-treating said composite particles at a second temperature for a second period of time wherein said second temperature is higher than the first heat treatment temperature and comprises a temperature selected from 900° C. to 3,500° C.

3. The method of claim 2, wherein said biochar particles are produced by the first heat-treating step that entails heat treating said biomass feedstock at a first temperature selected from a range of 100° C. to 1,500° C. for a first period of time to produce partially or fully carbonized biochar particles.

4. The method of claim 3, further including mechanically reducing a size of the biochar particles to an average size range from 10 nm to 10 mm.

5. The method of claim 2, wherein said biomass feedstock comprises a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof.

6. The method of claim 5, wherein said lignocellulosic biomass is selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, or a combination thereof.

7. The method of claim 5, wherein said non-lignocellulosic biomass is selected from food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, or a combination thereof.

8. The method of claim 1, wherein said carbon precursor is selected from petroleum heavy oil or pitch, coal tar pitch, a polynuclear hydrocarbon, a polymer, or a combination thereof.

9. The method of claim 8, wherein said polynuclear hydrocarbon is selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

10. The method of claim 8, wherein said polymer is selected from polyacrylonitrile (PAN), polyvinyl chloride (PVC), polyether ether ketone (PEEK), polysuifone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof.

11. The method of claim 2, wherein said biomass comprises an additive dispersed in said biomass during said first heat treating step, wherein said additive comprises an activator or activating agent.

12. The method of claim 11, wherein said activation agent is selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

13. The method of claim 11, wherein said additive further comprises a catalyst, a template, or a nucleating agent.

14. The method of claim 2, wherein said procedure of activating the biochar particles comprises a physical activation or chemical activation procedure.

15. The method of claim 14, wherein said physical activation comprises using a water steam or gaseous CO₂, or the chemical activation procedure comprises using an activation agent selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

16. The method of claim 1, wherein the pores have a pore size greater than 50 nm, a porosity greater than 50% by volume, or comprise interconnected pores or through pores.

17. The method of claim 1, wherein the graphitic or carbonaceous particles have a density from 0.1 to 2.26 g/cm³.

18. The method of claim 2, wherein said first heat treating comprises a hydrothermal carbonization (HTC) of the biomass at an HTC temperature selected from 100° C. to 600° C. for a first duration of time, and the second heat treating step comprises a pyrolysis procedure at a pyrolysis temperature higher than the selected HTC temperature for a second length of time.

19. The method of claim 18, wherein a catalyst, a template, an activator, a chemical functionalization agent, or a combination thereof is present during the HTC and/or pyrolysis procedure.

20. The method of claim 18, wherein said hydrothermal carbonization comprises heat treating said biomass feedstock to induce decomposition of biomass molecules, polymerization, and/or aromatization at a desired first temperature and under a desired pressure for a first length of time for forming a mixture of graphene domains dispersed in a disordered matrix of carbon or hydrocarbon molecules, wherein said graphene domains are each composed of one or a plurality of planes of hexagonal carbon atoms or fused aromatic rings having a length or width from 5 nm to 10 μm.

21. The method of claim 19, wherein said catalyst comprises B, P, a transition metal selected from Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.
